(19) United States
(12) Patent Application Publication
(10) Pub. No.: US 2005/0265584 A1
(43) Pub. Date: Dec. 1, 2005

(54) Imaging systems and methods

(76) Inventors: Stephen E. Dobson, Green Bay, WI (US); Patrick P. Clancey, Green Bay, WI (US)

Correspondence Address: WILHELM LAW SERVICE, S.C., 100 W LAWRENCE ST, THIRD FLOOR, APPLETON, WI, 54911, US

(21) Appl. No.: 11/139,808

(22) Filed: May 27, 2005

Related U.S. Application Data
(60) Provisional application No. 60/575,668, filed on May 28, 2004.

(51) Int. Cl. G06K 9/00

(52) U.S. Cl. 382/104

(57) ABSTRACT

Imaging systems which can operate in both visible spectrum and the near infrared spectrum, optionally incorporating the implementation of a long pass filter on an imaging camera. The imaging systems can detect edges of objects in various weather conditions, including in ambient conditions which include substantial fog, precipitation, or other moisture-laden air. Imaging systems of the invention can enhance detected edge locations or other image characteristics, pass the locations of such characteristics, or data representative of the locations of such characteristics, to a computer, which can use the information as basis for controlling a commercial operation such as directing the location of a vehicle, to be washed, in a commercial vehicle wash, and/or to direct various steps in the vehicle washing operation. The invention can provide enhanced surveillance features by making the long pass filter an optional screen through which the incident light passes, before reaching the camera sensor array.

### BACKGROUND

This invention pertains generally to imaging systems, and methods of using imaging systems to capture images of objects.

As used herein, “imaging”, “imaging technology”, and “imaging systems” refer to machines which can capture images of objects automatically as instructed, at pre-determined intervals, optionally on an instruction-by-instruction basis, e.g. upon the occurrence of pre-determined events, or the like. Such images are then manipulated electronically to achieve desired objectives.

In the invention, such images can be used in achieving a wide variety of objectives, such as any of a wide variety of quality control inspections, or verifying presence or absence of an object at a specified location at a specified time, or monitoring activity in a given area which is being kept under surveillance by the camera.

Images are generally captured using an imaging camera. Available imaging cameras can sense objects using a variety of wave lengths, including visible wave lengths, infrared wave lengths, and near infrared wave lengths. Both analog and digital cameras are available. In any event, the image is typically captured using an array of sensors. The sensory array produces an electronic image which is generally referred to as having an array of pixels, wherein each pixel represents the portion of the image which is captured using one of the sensors.

While imaging systems have been used to detect objects in an image, it would be desirable to be able to detect an edge or other characteristic of an object.

It would be further desirable to detect an outside edge of an object.

It would be still further desirable to detect an outside edge or other characteristic of an object under conditions of poor visible light.

It would be yet further desirable to detect an edge or other characteristic of an object under conditions where the ambient air is saturated with moisture to the extent of obscuring visibility using the visible spectrum.

It would also be desirable to detect an outside edge or other characteristic of an object under ambient foggy or precipitation conditions.

It would further be desirable to be able to enhance an image of an object by using a camera which has an integrated long pass filter to filter out visible wavelength light.

### SUMMARY OF THE DISCLOSURE

Imaging systems of the invention can operate in both the visible, and near infrared wavelengths of the electromagnetic spectrum. Near infrared wavelengths are those wavelengths which have wavelengths greater than the wavelengths of the visible light spectrum and shorter than the wavelengths of the infrared spectrum.

As used herein, “visible wavelengths” or “visible light” means wavelengths of about 400 nanometers up to about 770 nanometers.

As used herein, “near infrared wavelengths” means about 770 nanometers to about 1400 nanometers.

Imaging systems of the invention can be used to detect edges of objects in various weather conditions, including in ambient conditions which can be characterized as fog, precipitation/rain, or other moisture-laden air. Imaging systems of the invention can pass the locations of such edges, or data representative of the locations of such edges, to e.g. a computer or computing system, which can use the information as basis for controlling a commercial operation such as directing the location of a car, to be washed, in a commercial car wash, and/or to direct various steps in the car washing operation.

In a first family of embodiments, the invention comprehends an imaging system, adapted and configured to detect a target object. The imaging system comprises an image receiving camera which receives image information related to the target object, the image receiving camera comprising an array of sensors, and having a light travel path, the camera being adapted to transmit messages sensed at both visible wavelengths and at near infrared wavelengths; a long pass filter in the light travel path of the image receiving camera; interface apparatus which translates the image information into machine language and a computer which has access to target image information, and wherein said computer receives such translated image information in such machine language, and compares the received image information to the target image information, and thereby determines location of such target object.

In some embodiments, the long pass filter is movable, upon command of the computer, at least one of (i) into the light travel path and (ii) out of the light travel path.

In some embodiments, the imaging system further comprises an illuminating light of sufficient intensity, and at a wavelength which is being passed through to the array of sensors, so as to enhance at least one of clarity of the image or intensity of the image.

In some embodiments, the imaging system further comprises image enhancement software, for example edge enhancement software, associated with the computer, thereby to enhance the images, edges, so captured by the imaging system.

In a second family of embodiments, the invention comprehends a vehicle wash bay, comprising a plurality of generally enclosing walls, optionally an open framework, defining a vehicle wash bay enclosure, and defining access to the vehicle wash bay enclosure, for vehicle entrance into, and exit from, the vehicle wash bay enclosure; vehicle washing apparatus adapted and configured to wash a vehicle positioned in the vehicle wash bay; and an imaging system, adapted and configured to detect a vehicle in the vehicle wash bay, the imaging system comprising (i) an image receiving camera which receives image information related to such vehicle, the image receiving camera comprising an array of sensors, (ii) interface apparatus which translates the image information into machine language: and (iii) a computer which has access to target image information, and wherein the computer receives the translated image information in the machine language, and compares the received image information to the target image information, and thereby determines location of the vehicle.

In some embodiments, the camera further comprises a filter, optionally a long pass filter, which filters out visible wavelength light, and which is optionally movable, upon command of the computer, at least one of (i) into the light travel path and (ii) out of the light travel path.

In a third family of embodiments, the invention comprehends a method of detecting target objects within a target zone. The method comprises establishing the target zone within which the target object is to be detected; periodically collecting images in the target zone, using an imaging system which is adapted and configured to detect a such target object, the imaging system comprising (i) an image receiving camera which receives the image information at near infrared light wavelengths, and optionally at other wavelengths, the image receiving camera comprising an array of sensors, and having a light travel path, (ii) interface apparatus which translates the image information into machine language, and (iii) a computer which has access to target information, and wherein the computer receives the image information, and compares the received image information to the target image information, and thereby determines the location of such target object; processing the collected images, including enhancing the images and thereby producing enhanced images which have been clarified and/or enhanced, according to enhanced object characteristics in the images; determining, for respective target objects, whether clarity or sharpness of an image can be enhanced by interposing a long pass filter in the light path and, where clarity or sharpness of the image can be so enhanced, selectively interposing such long pass filter in the light path; and issuing action commands based on the enhanced object characteristics of the images.

In some embodiments, the method further comprises moving the filter into the light travel path and out of the light travel path, in response to commands from the computer, or commands from an operator.

In some embodiments, the method further comprises capturing first and second images, approximately next adjacent in time, and closely adjacent in time, wherein the long pass filter is in the light travel path during capture of one of the images, and out of the light travel path during capture of the other of the images, comparing the first and second images for clarity and thus selecting one of the first and second images as having greater clarity than the other, and further processing the selected image.

In some embodiments, the computer contains enhancement software which enhances image characteristics, optionally edges, the method comprising enhancing characteristics, edges, in the images according to pre-determined threshold pixel signal intensity value, plus optionally according to location proximity to a known qualifying signal in the same image.

In a fourth family of embodiments, the invention comprehends a method of controlling a vehicle wash facility. The vehicle wash facility comprises a vehicle wash bay defined by a plurality of upstanding walls or a framework, a floor, and optionally a roof, and vehicle wash apparatus in the vehicle wash bay. The method comprises establishing a target zone in the vehicle wash bay; periodically collecting images in the target zone, using an imaging system which is adapted and configured to detect at least one characteristic of a vehicle in the wash bay, the imaging system comprising (i) an image receiving camera which receives the image information, the image receiving camera comprising an array of sensors, (ii) interface apparatus which translates the image information into machine language, and (iii) a computer which has access to target image information, and wherein the computer can compare the translated image information to the target image information, and thereby determine the location of the at least one characteristic of the vehicle in the wash bay; processing the collected images, including enhancing the images and thereby producing enhanced images which have been clarified and/or enhanced with respect to the at least one vehicle characteristic in the images; and based on the enhanced images, issuing action commands to the vehicle wash apparatus, thereby to control the vehicle wash apparatus.

In some embodiments, the image receiving camera has a light travel path, the camera being adapted to record images at both visible wavelengths and near infrared wavelengths, the method further comprising imposing, in the light travel path, a filter which filters out visible wavelength light.

In some embodiments, the method further comprises moving the filter into the light travel path and out of the light travel path, in response to commands from the computer, or in response to commands from an operator.

In some embodiments, the computer contains characteristic enhancement software, optionally edge enhancement software, which enhances image characteristics, edges, the method comprising enhancing characteristics, edges, in the images according to pre-determined threshold pixel signal intensity values.

In some embodiments, the issuing of commands to the vehicle wash apparatus includes at least one of “admit vehicle to the bay”, “stop vehicle”, “start wash cycle”, “stop wash cycle”, “move apparatus”, and “terminate cycle”.

In a fifth family of embodiments, the invention comprehends a camera-based imaging system, adapted and configured to enhance image clarity during adverse weather conditions. The camera system comprises an image receiving camera which receives image information related to the operational field of view of the camera at at least one of visible light wavelengths and near infrared wavelengths. The camera comprises an array of sensors, and has a light travel path. The camera is adapted to transmit images sensed at both visible light wavelengths and at near infrared light wavelengths. Interface apparatus translates the image information into electronic visual information which can be presented visually on a video monitor. The image receiving camera has a light travel path, and is designed to transmit images received at both visible wavelengths and at near infrared wavelengths, the image receiving camera further comprising a filter, optionally a long pass filter, which filters out the visible wavelength light.

In some embodiments, the camera-based imaging system further comprises an illuminating light of sufficient intensity, and at a wavelength which is being passed through the camera to the array of sensors, so as to enhance at least one of clarity of the image or intensity of the image.

In some embodiments, the camera-based imaging system further comprises image enhancement software associated with the computer, thereby to enhance the images so captured by the imaging system.

In some embodiments, the filter is movable, upon command of the computer, at least one of (i) into the light travel path and (ii) out of the light travel path.

In some embodiments, the imaging system further comprises a video monitor which receives and/displays the visual information.

### BRIEF DESCRIPTION OF THE DRAWING

FIG. 1 is a block diagram of the invention, including a representative illustration of a vehicle in the environment of an automatic vehicle wash.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

An imaging system of the invention generally includes (i) a camera or other energy receiving device, (ii) an optional optical filter, (iii) an interface device, and (iv) an optional computer.

The camera can be sensitive to either the visible wavelength frequencies or the near infrared wavelength frequencies, and may be sensitive to both the visible wavelength frequencies and the near infrared wavelength frequencies. The camera has an array of receivers, each of which is capable of sensing a portion of an image of a target object, thus generating a pixel response representative of that portion of the image. The array of receivers is collectively capable of detecting an image or image segment, pixel-by-pixel, of a target object, and creating a pixel-by-pixel electronic image representation of the target object. The optional filter can block or substantially impede transmission of substantially all visible light to the camera sensors.

The interface device translates the image information received from the camera, as needed, into machine language, thereby enabling and/or facilitating transfer of the collected image or image information to the computer in such format that the computer can appropriately manipulate the data to the benefit of the analyses to which the invention is directed. Or the interface can simply export the image information to a read-out, such as a video monitor, a digital read-out, an analog read-out, or a chart.

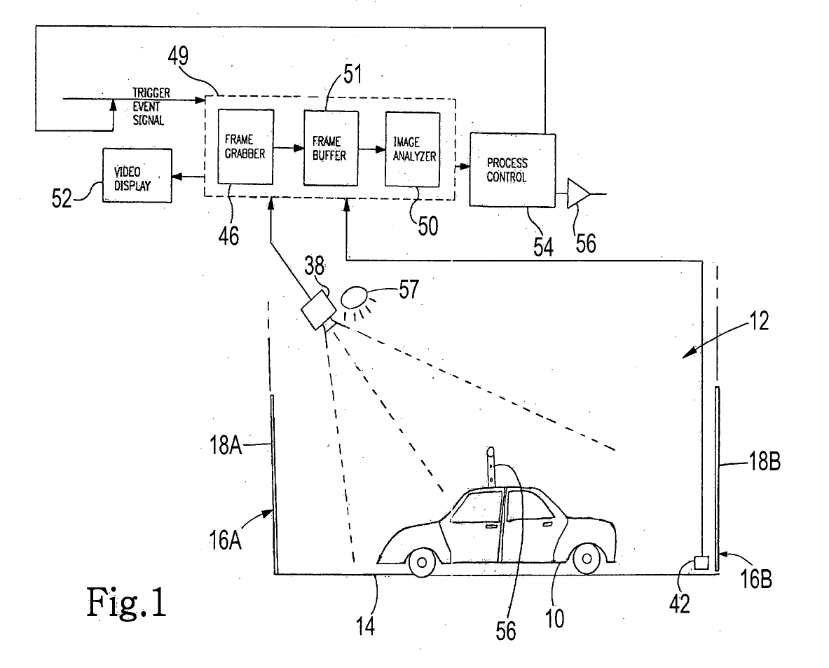

As used herein, “computer” and “computer system” includes hardware commonly associated with commercial grade programmable logic computers (PLC) or the like, or personal computer (PC), as well as software typical and appropriate to the expected application of the computer or the computer system, including commonly-used industrial or commercial grade software. Specific hardware and/or software additions or changes are also included to the extent appropriate to meet objectives of a specific implementation of the invention, and to the extent commonly available as services of those skilled in the software services trade. In addition, the computer can be embodied in any number of separate and distinct computer modules, which can be housed in a single housing or in multiple housings wherein the various modules communicate with each other in performing the computing functions referred to herein. Typically, the computer is housed in a single housing commonly deployed as a single personal computer, e.g. PC. Typical such PC's are available from Dell Computer, Round Rock, Tex., and are denoted herein and in FIG. 1 as process control computer 54.

In the alternative, the computer can be a hard-wired device, e.g. chip, specific to the application, which has only limited programming capability.

The process control computer, e.g. PC, is typically pre-loaded with a database of image target measurements and/or image fragments which are representative of objects, or object elements, or object measurements, or fragments of object outlines, which are desirably to be detected as the imaging system is being used. For example, if the imaging system is to be used to detect edges or other characteristics of vehicles in a vehicle wash bay, the database is loaded with images, and/or image fragments and/or potential image target location measurements, which represent outlines of the edges, portions of the edges, or distance references of acceptable vehicle position, of vehicles which potentially will enter the vehicle wash bay.

The detected characteristic, e.g. edge, can be a portion of the respective characteristic of the vehicle, or can be an entire e.g. outline of the vehicle taken from the angle at which the detect camera is to be mounted in the wash bay.

Where an intended result is to locate an object, or an edge of an object, in an image, thereby to use the detected location to perform a desired function, the process control computer analyzes the image or image information received from the camera and determines the representative location of the respective characteristic in the image or image information of the object, or the targeted characteristic of the target object.

Imaging systems of the invention are designed and configured to operate in typical ambient daylight conditions or under adverse light and/or light transmission conditions, and are especially capable of operating in adverse ambient light conditions with the optional additional condition of high levels of moisture in the air, e.g. so much moisture as to impede a person's ability to see an object through such atmospheric conditions using visible light.

A typical use for imaging systems of the invention is to sense the location of a vehicle in a vehicle wash bay, under the whole range of visibility conditions which occur during the operation of a vehicle wash system. Thus, imaging systems of the invention are adapted to see through the fog and spray which is commonly present as a vehicle is being serviced. For example, under cold weather conditions, and where humidity levels inside the closed vehicle wash bay are quite high, when the door opens to let a vehicle in, the incoming cold air causes condensation of the high levels of moisture already present inside the vehicle wash bay. Such condensation of air-borne moisture causes a fog effect in the bay, such that visibility of the vehicle, entering the bay, is impeded at precisely that time which is critical to proper placement of the vehicle for washing with the automatic equipment which is to be used to wash the vehicle.

Such vehicle wash bay is defined by a plurality of generally enclosing walls, possibly including one or more doors. The vehicle wash bay houses washing apparatus adapted and configured to wash a vehicle in the bay. The vehicle wash facility can employ multiple such bays, and can optionally include a central remote control station, as well as having various controls and sensors in the respective bays, which enable a user to simultaneously sense and control the operation of washing operations in various ones, or in all, of the bays.

In place of enclosing walls, the individual wash bay can be defined by open framework.

A representative car wash bay is illustrated in FIG. 1, which shows a vehicle 10 in a bay 12 represented by floor 14 and walls 16A, 16B. Wall 16A includes a doorway, and a door 18A in doorway 16A. Wall 16B includes a doorway, and a door 18B in doorway 16B. While vehicle 10 is illustrated as a car, the vehicle can as well be a van, a light duty truck, medium-duty truck, heavy-duty truck, special purpose vehicle such as an ambulance, a special-purpose truck, or any other vehicle desired which can fit inside the targeted area where vehicles are to be washed.

At least camera 38 of the imaging system is deployed in the bay, or looks, through e.g. a window, into the bay. The remaining elements of the imaging system can be either in the bay, or in another location.

In the embodiment illustrated, image trigger device 42 is positioned generally at wall 16B, adjacent the doorway, and adjacent door 18B, in wall 16B where the vehicle enters the wash bay. Image trigger device 42 can be, for example and without limitation, an electric eye, other sensor, or remote signal which is activated by sensing, for example, the vehicle passing through the doorway of the bay. This activation provides a signal to vision system 49 to commence monitoring the target location for advance of the vehicle. Vision system 49 includes frame grabber 46, frame buffers 51, and image analyzer 50.

Image trigger device 42 sends detect signals to frame grabber 46 and light 57 which may be a continuously-illuminated light, or a strobe light. Light 57 is optionally used only where lighting conditions warrant, or where the use of such light otherwise enhances the value, e.g. clarity and/or sharpness, of the image being captured. The detect signal can synchronize firing of the respective strobe light, where used, and the grabbing, by frame grabber 46, of the respective frame or image of the vehicle, which frame or image is being transmitted from the camera. Images are repeatedly captured, at a predetermined repeat rate of the camera until analysis of the image indicates that the vehicle has arrived at the target location where characteristics, e.g. outer edges, of the vehicle correspond with one or more of the image target measurements in database storage.

A given grabbed frame is transmitted by frame grabber 46 to frame buffer 51, whereby the frame grabber transfers an electronic representation of a visual image of the vehicle in accord with the detect signal which was created by the passing of the vehicle through the door into the wash bay. While the image trigger device 42 is illustrated as being adjacent to the doorway which leads into the wash bay, the trigger device can be at any location compatible with timely sensing of the entrance of the vehicle into the wash bay.

The image so collected is sent by frame grabber 46 to frame buffer 51, thence to image analyzer 50 where the process control computer attempts to match the grabbed image with at least one of the image target measurements or image fragments in computer memory, such as in the stored database of image target measurements and image fragments.

After being so processed by vision system 49, the processed camera signal may be sent to video image display device 52, such as a video monitor, where e.g. an operator can watch the progress of the wash activity based on the images being collected by camera 38.

The image signals collected by camera 38 are processed by frame grabber 46 and image analyzer 50, thereby converting the images received from the camera, as expedient and appropriate, into digitized representations of the images so recorded. The results of such analyses are fed to process control computer 54. Process control computer 54 receives such results signals and issues output commands, as appropriate, to the various pieces 56 of washing and drying equipment used in the washing process, for example and without limitation, to start, adjust, modify, and stop the various steps in the washing process and/or the drying process, in accord with the measurements and/or image fragments stored in computer memory. Such washing and drying equipment communicate back to process control computer 54, as usual, regarding the progress of the washing and drying operations.

Camera 38 continues to repeatedly grab images, and send the respective images to the image analyzer, thus to process control computer 54, which may optionally monitor the vehicle location to ensure that the vehicle remains at the target location throughout the washing process. In some embodiments, camera 38 continues to grab images at the desired repeat rate, or other frequency-limiting element of the imaging system, so long as the vehicle is in the image window which can be viewed by the camera, thereby to sense any inadvertent movement of the vehicle during the washing process.

Once the washing process has been completed, the vehicle is processed out of the bay. The images from camera 38 optionally may then confirm that no vehicle is present in the wash bay. In such case, process control computer 54 can communicate to the wash equipment to admit the next vehicle, and to alert trigger device 42 to watch for the next incoming vehicle.

Where the intensity of ambient light is so low as to call into question the ability of the camera to readily sense the target object, an appropriate light source such as light 57 is used to project illuminating energy of the desired frequency range onto the object to be sensed, thereby to assist with the detecting/sensing of the object under such adverse conditions. In systems which are capable of grabbing images in both the visible spectrum and the near-infrared spectrum, and where substantial levels of fog or other obscuring moisture are present, illumination is provided in the near infrared spectrum. Where obscuring moisture is absent or at low levels, the illumination can optionally be provided in the visible spectrum.

In the image processing, once the image or image information has been collected, whether using visible light or near infrared light, the utility of the collected information can be enhanced using digital image filtering and optionally edge enhancement, or other image enhancement, techniques. Once the image has been enhanced, the image is analyzed by process control computer 54 to find the image characteristic, such as an edge, which most closely matches a measurement or image fragment in the database which corresponds to the respective target object.

The database of target image information is typically stored inside process control computer 54. In the alternative, the database information can be stored at a remote location outside the process control computer, optionally off-site, but the so stored data is nevertheless accessible to the process control computer by any of a variety of known communications media, including both wired and wireless, using readily available hardware and software.

The stored data, in general, represent the location of one or more edges, or other characteristics of any of a plurality of target elements on any of a plurality of objects. Positions of such characteristics within the image or image information can be located using computer analysis and, using scaling techniques, can be scaled to the environment surrounding the target object. The resultant scaling output can be used to establish the location of the target characteristic of the target object in relation to another object or location known to, typically previously defined to, the imaging system.

Once the magnitude of the scaling output is determined, the scaling output can be passed to analysis software in the process control computer, or can be passed to another computer, remote from process control computer 54, using any of a wide variety of data transmission techniques.

Imaging systems of the invention can potentially be used in any situation where the location of an object is to be monitored or measured automatically and where the object has a visually definable characteristic which can be detected by an imaging system of the invention. For example, imaging systems of the invention are well suited to finding the location of an edge of a vehicle, or the edge or edges of one or more elements of a vehicle, in a vehicle wash, or other image characteristic of a vehicle in a vehicle wash. Imaging systems of the invention can thus be used to provide position information which can be employed to determine location and/or orientation of a vehicle in the vehicle wash. Such location and/or orientation information can then be used as basis for controlling movement of the wash equipment or the vehicle, during the washing process.

Completely separate from the vehicle wash environment, imaging systems of the invention can be used to control automatic measurement of x and y components, e.g. length and width, of a container or other object under adverse visibility conditions.

Where good lighting is available, imaging systems of the invention may use the visible range of frequencies of the electromagnetic wave spectrum as the primary means of detecting an object, or an edge of an object or another characteristic of an object. However, where the object is not readily detected using visible light, the sensors in the camera, which are sensitive to the near infrared spectrum as well as to visible wavelengths, continue to pick up the near-infrared signals, whereby an image can be grabbed by the imaging system in even such adverse moisture conditions.

In adverse ambient conditions such as fog, heavy mist, rain, or other conditions where the air contains a high degree of moisture, e.g. high relative humidity such as at or above the dew point, light waves in the visible spectrum are scattered by the moisture droplets. In such instance, the clarity of any image received from the object, by way of the visible spectrum, is degraded as a function of the intensity of the fog affect, water droplet affect, or the like. Image clarity is further affected by the distance which must be traversed by such light waves, between the object and the camera sensors. Clarity and intensity of the image information so sensed is thus affected by both density of the fog/water factor in the atmosphere, and the distance between the object and the camera.

A typical camera, of the type contemplated for use in the invention, operates based on the image information received at both the visible and the near infrared frequencies, combined. Where a high water level is present in the respective environment, e.g. high relative humidity to the point of negatively affecting acuity of the image captured, the image information received at the visible frequencies is sufficiently obscured by the presence of the water/fog, that the camera does not well detect the object or object element which the user seeks to detect.

In addition, while the image can well be detected at the near infrared spectrum, the image information received at the visible portion of the camera's spectrum of sensitivity can be sufficiently intense to obscure the image information received at the near infrared frequencies, whereby the overall image is undesirably degraded, obscure. Accordingly, where high levels of water or water vapor are typically encountered in the environment in which the camera is expected to be used, the camera is equipped, optionally integrally equipped, with a filter, such as a long pass filter, which filters out the visible light.

In general, and given ideal lighting conditions, an image produced using visible light has a sharper image than an image produced using near infrared light. However, an image produced using visible light under high moisture conditions is degraded to the extent the moisture scatters the visible light waves. Near infrared radiation is scattered to a lesser degree. Where the scattering is sufficiently great, the lesser proclivity of the near infrared lightwaves to being scattered by moisture results in the image produced using only the near infrared light having greater clarity than a corresponding image produced using visible light, or the combination of visible light and near infrared light.

Accordingly, where the working environment of an imaging system of the invention contemplates high levels of air-borne moisture, such as fog, spray, mist, precipitation, or the like, a visible spectrum filter is installed on the camera, in the light path of the camera, to filter out visible light, whereby the light which reaches the camera sensors, and to which the camera sensors can respond, is limited to radiation in the near infrared spectrum. In such case, the visible light never reaches the camera sensors whereby the camera sensors sense only the near infrared light.

Since the near infrared light waves are less prone to incident reflection and scattering than visible light waves under high moisture conditions, even though the near infrared light waves generally produce a less sharp image than visible light waves, under such conditions, the near infrared wave length produces the relatively more discernible image.

Given the relative wave lengths, the images produced by the near infrared wave lengths are relatively sharper, more distinct, and more like images produced from visible wave length light, than images generated using infrared light, namely frequencies above 1400 nanometers. Accordingly, the images produced using the near infrared spectrum are generally superior in clarity to images produced using the infrared spectrum.

Thus, imaging systems of the invention generate highest clarity images using the visible spectrum. However, the camera is adapted and configured to also capture images and image information using the near infrared spectrum. Depending on the use environment, the camera is optionally equipped with the respective optical filter where near infrared light is expected to result in images having relatively greater clarity.

Where the optical filter is not used, the image can represent, in part, receipt of the visual spectrum light waves and, in part, receipt of the near infrared spectrum light waves, whereby the resulting information passed to the process control computer is a combination result of the receipt of signals in both the visible spectrum and the near infrared spectrum.

Where it is desired to use primarily near infrared wave length light, camera sensors which are sensitive to near infrared light waves and are insensitive to visible light waves, can be used. In the alternative, the camera lens can be covered with a long pass filter, or such filter can otherwise be interposed into the light path of the camera. The filter blocks visible spectrum wavelengths, namely wavelengths below about 770 nanometers. Such optical filter effectively prevents the visible light waves from reaching, or being received by, the sensors in the sensor array.

Such filter, which blocks visible spectrum wavelengths, can be installed on the camera, as e.g. an integral part of the camera, with a “filter-in” option where the filter filters out visible spectrum wavelengths, and a “filter-out” option where the filter does not filter out visible spectrum wavelengths. Computer 54 is programmed to optionally cycle the camera through both the “filter-in” and “filter-out” configurations, and the image processing system is designed to select the sharper of the two images for further processing through the decision-making process. An operator can, in the alternative, determine filter use manually, thus to over-ride the automatic decision-making capability of the computer, regarding filter use.

Once an image, or image information, is collected by the camera and received and accepted for processing, by the process control computer, filter software is used to filter the image to highlight edges or other image characteristics in the areas of interest. Once filtered, line detection analysis is used to locate a characteristic of interest which represents a suitable match to a measurement or image fragment in the stored database.

After such characteristic is detected, the location of the characteristic is scaled to match a desired distance or angle measurement unit. A distance or angle from a known object in relation to the camera is calculated, thereby to define to the imaging system the location of the target characteristic. The location of the detected characteristic can be stored in the imaging system, or can be sent to other portions of the imaging system for use. For example, the location of a detected edge can be used to generate e.g. a stop or start signal to effect stopping, or starting, or continuing, an action. For example, when a vehicle enters a vehicle wash, the location of the vehicle can be monitored, namely sensed repeatedly at small intervals of time. When the vehicle reaches a desired location in the wash bay, a “stop” signal can be generated, which illuminates a sign which instructs the driver of the vehicle to stop the vehicle.

Such location determination can also be used to generate a command which starts the wash cycle. The location of the vehicle can be monitored during the course of the wash cycle such that, if the vehicle should move, any wash equipment in the way of vehicle movement direction is automatically signaled, instructed to move out of the path of the vehicle, and/or to stop the washing process.

Further, as the vehicle leaves the wash bay, any continuing wash or dry activity still in operation can be stopped as soon as the vehicle is out of effective range of such activity, thereby preserving resources of the wash operator, whether water, soap, drying heat or air, or the like. In addition, if the vehicle leaves the wash bay earlier than expected, the next vehicle in line can be immediately processed into the wash system for washing, thereby effectively reducing effective cycle time of the wash operation.

A typical camera useful in the invention is conventionally known as a CCD RS170 camera, and is sensitive to both visible spectrum wave lengths and near infrared spectrum wave lengths. An exemplary such camera is an Extreme CCTV model number EX10, available from Extreme CCTV Surveillance Systems, Burnaby, BC, Canada.

An e.g. 800 nanometer long pass filter can be used as desired to block transmission of the visible light spectrum e.g. in adverse weather conditions such as high fog conditions, misting conditions, or other precipitation conditions, and the like. The camera can be used without such filter in non-adverse weather conditions, such as sunny or partly-cloudy weather conditions.

A PCI bus Frame grabber can be used to capture the image data from the camera/receiver, and to transfer such image and/or image data from the camera to the computing system.

Edge Enhancement Example: Gaussian Filter software is used with specific parameters for each specific application. The Gaussian filter table is run over the area of interest within the image, for example and without limitation

| | | | | |
|---|---|---|---|---|
| 1 | 4 | 7 | 4 | 1 |
| 4 | 16 | 26 | 16 | 4 |
| 7 | 26 | 41 | 26 | 7 |
| 4 | 16 | 26 | 16 | 4 |
| 1 | 4 | 7 | 4 | 1 |

After the Gaussian filter has been employed, an edge enhancing filter such as the Sobel matrix is typically run over the area of interest. The Sobel matrix can be represented by, for example and without limitation,

$$\begin{matrix}- 8 & 0 & 8 \\ - 16 & 0 & 16 \\ 8 & 0 & 8\end{matrix}$$

To eliminate spurious edges, after the Sobel filter, pixel value within the image can be set to “0” if the enhanced value is, for example, less than 140.

After the edge enhancement, a computer analysis tool is used to determine the best line which defines the outside edge of the target object.

First, a search is started from e.g. the lower outside edge (right side for an object where the edge is anticipated to be detected on the right side of the object, and vice versa) traveling first up and then laterally, column by column, until a white pixel, e.g. an enhanced signal value of at least 140, preferably at least 200, or any other distinguishing or discriminating value, is found in a pixel. Vertical upward continuity of the white pixel designation is then assessed. One by one, pixels vertically adjacent the last known white pixel, and any other adjacent pixel, including pixels at 45 degree angles to the last known white pixel, are sensed.

If the value of a respective adjacent pixel is greater than the discriminating value, the respective pixel is considered to be a white pixel, and to be part of a line of such white pixels. Any substantially unbroken line of e.g. about 45 or more such white pixels in the target area, namely where an edge is potentially susceptible of being detected, is considered to be at least part of the line which provides the edge, e.g. an outside edge being searched for, or monitored, and the analysis is terminated because the objective of locating the target outside edge has been accomplished. The calculated locations of the respective white pixels are then scaled to real world measurements and the location of the corresponding edge of the target object, in relation to some other known object in the respective environment of the target object, is thereby determined. Once the real world location of the target has been determined, the location information can be used in performing certain predetermined or later determined tasks, in accord with the desires of the user of such imaging systems.

In an alternative embodiment of imaging systems of the invention, a camera, which is otherwise sensitive to both visible light and near infrared light wavelengths, includes a long pass filter integrally incorporated into the camera. Interface apparatus translates the image into a second language which can be used by a downstream processor. The downstream processor receives the translated image information and uses that information to accomplish a desired task, such as to display a visual representation of the captured image on a video monitor. Or the downstream processor can use the information to accomplish, or order accomplishment, of an action. For example, a computer controller 54 may compute, and order, an action such as in a vehicle washing environment.

Whether or not an image trigger device 42 is used depends on the actions being contemplated. For example, in a vehicle wash environment, image trigger device 42 is beneficially used to turn off camera 38 when no vehicle activity is anticipated, thus reducing wear on the camera.

By contrast, where the imaging system is being used in a surveillance environment, such as monitoring safety and/or security issues, the camera is in constant use over extended periods of time whereby a trigger device is not needed. Nevertheless, the image clarity benefits of filtering out visible wavelength light under adverse weather conditions, and optionally including visible wavelength light under less adverse weather conditions, implements the value of the invention.

The invention can be used in a wide variety of environments to detect and monitor intermittently present target objects, under a wide array of weather conditions, including adverse weather conditions as discussed herein. Whether a trigger device 42 is used depends on whether imminent presence of the target object, in the image window, can be detected, or is important to accomplishing the desired objective. Thus, for a vehicle wash, a trigger device is desirable. By contrast, for a general surveillance implementation, it may be impossible to set up a reliable trigger event system whereby the trigger device is not used. In other implementations, a trigger signal may be possible to set up, but may have little value, whereby no trigger device is used. But if a trigger device will provide valuable information, then the trigger device will be used.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. An imaging system, adapted and configured to detect a target object, said imaging system comprising:
(a) an image receiving camera which receives image information related to such target object, said image receiving camera comprising an array of sensors, and having a light travel path, said camera being adapted to transmit messages sensed at both visible wavelengths and at near infrared wavelengths;
(b) a long pass filter in the light travel path of said image receiving camera;
(c) interface apparatus which translates the image information into machine language; and
(c) a computer which has access to target image information, and wherein said computer receives such translated image information in such machine language, and compares the received image information to the target image information, and thereby determines location of such target object.

2. An imaging system as in claim 1 wherein said long pass filter is movable, upon command of said computer, at least one of into the light travel path and out of the light travel path.

3. An imaging system as in claim 1, further comprising an illuminating light of sufficient intensity, and at a wavelength which is being passed through to the array of sensors, so as to enhance at least one of clarity of the image or intensity of the image.

4. An imaging system as in claim 1, further comprising image enhancement software associated with said computer, thereby to enhance the images so captured by said imaging system.

5. An imaging system as in claim 1, further comprising edge enhancement software associated with said computer, thereby to enhance the edges so captured by said imaging system.

6. A vehicle wash bay, comprising:
(a) a plurality of generally enclosing walls, optionally an open framework, defining a vehicle wash bay enclosure, and defining access to said vehicle wash bay enclosure, for vehicle entrance into, and exit from, said vehicle wash bay enclosure;
(b) vehicle washing apparatus adapted and configured to wash a vehicle positioned in said vehicle wash bay; and
(c) an imaging system, adapted and configured to detect a vehicle in said vehicle wash bay, said imaging system comprising
(i) an image receiving camera which receives image information related to such vehicle, said image receiving camera comprising an array of sensors,
(ii) interface apparatus which translates the image information into machine language: and
(iii) a computer which has access to target image information, and wherein said computer receives such translated image information in such machine language, and compares the received image information to the target image information, and thereby determines location of such vehicle.

7. A vehicle wash bay as in claim 6, said camera further comprising a filter which filters out visible wavelength light.

8. A vehicle wash bay as in claim 7 wherein said image receiving camera has a light travel path, and wherein said long pass filter is movable, upon command of said computer, at least one of into the light travel path and out of the light travel path.

9. A vehicle wash bay as in claim 6, further comprising an illuminating light of sufficient intensity, and at a frequency which is being passed through to the array of sensors, so as to enhance at least one of clarity of the image or intensity of the image.

10. A vehicle wash bay as in claim 6, further comprising image enhancement software associated with said computer, thereby to enhance images so captured by said imaging system.

11. A vehicle wash bay as in claim 6, further comprising edge enhancement software associated with said computer, thereby to enhance edges in images so captured by said imaging system.

12. A method of detecting target objects within a target zone, the method comprising:
(a) establishing the target zone within which the target object is to be detected;
(b) periodically collecting images in the target zone, using an imaging system which is adapted and configured to detect a such target object, the imaging system comprising
(i) an image receiving camera which receives the image information at near infrared light wavelengths, and optionally at other wavelengths, the image receiving camera comprising an array of sensors, and having a light travel path,
(ii) interface apparatus which translates the image information into machine language, and
(iii) a computer which has access to target information, and wherein the computer receives the image information, and compares the received image information to the target image information, and thereby determines the location of such target object;
(c) processing the collected images, including enhancing the images and thereby producing enhanced images which have been clarified and/or enhanced, according to enhanced object characteristics in the images;
(d) determining, for respective target objects, whether clarity or sharpness of an image can be enhanced by interposing a long pass filter in the light path and, where clarity or sharpness of the image can be so enhanced, selectively interposing such long pass filter in the light path; and
(e) issuing action commands based on the enhanced object characteristics of the images.

13. A method as in claim 12, further comprising moving the filter into the light travel path and out of the light travel path, in response to commands from the computer, or commands from an operator.

14. A method as in claim 13, further comprising capturing first and second images, approximately next adjacent in time, and closely adjacent in time, wherein the long pass filter is in the light travel path during capture of one of the images, and out of the light travel path during capture of the other of the images, comparing the first and second images for clarity and thus selecting one of the first and second images as having greater clarity than the other, and further processing the selected image.

15. A method as in claim 12 wherein the computer contains image enhancement software, the method comprising enhancing images according to pre-determined threshold pixel signal intensity values.

16. A method as in claim 13 wherein the computer contains enhancement software which enhances image characteristics, the method comprising enhancing characteristics in the images according to pre-determined threshold pixel signal intensity value, plus according to location proximity to a known qualifying signal in the same image.

17. A method as in claim 13 wherein the computer contains edge enhancement software which enhances image edges, the method comprising enhancing edges in the images according to pre-determined threshold pixel signal intensity value, plus according to location proximity to a known qualifying signal in the same image.

18. A method of controlling a vehicle wash facility, the vehicle wash facility comprising a vehicle wash bay defined by a plurality of upstanding walls or a framework, a floor, and optionally a roof, and vehicle wash apparatus in the vehicle wash bay, the method comprising:
(a) establishing a target zone in the vehicle wash bay;
(b) periodically collecting images in the target zone, using an imaging system which is adapted and configured to detect at least one characteristic of a vehicle in the wash bay, the imaging system comprising
(i) an image receiving camera which receives the image information, the image receiving camera comprising an array of sensors,
(ii) interface apparatus which translates the image information into machine language, and
(iii) a computer which has access to target image information, and wherein the computer can compare the translated image information to the target image information, and thereby determine the location of such at least one characteristic of such vehicle in the wash bay;
(c) processing the collected images, including enhancing the images and thereby producing enhanced images which have been clarified and/or enhanced with respect to the at least one vehicle characteristic in the images; and
(d) based on the enhanced images, issuing action commands to the vehicle wash apparatus, thereby to control the vehicle wash apparatus.

19. A method as in claim 18 wherein the image receiving camera has a light travel path, the camera being adapted to record images at both visible wavelengths and near infrared wavelengths, the method further comprising imposing, in the light travel path, a filter which filters out visible wavelength light.

20. A method as in claim 19, further comprising moving the filter into the light travel path and out of the light travel path, in response to commands from the computer, or in response to commands from an operator.

21. A method as in claim 20, further comprising capturing first and second images, approximately next adjacent in time, and closely adjacent in time, wherein the near infrared filter is in the light travel path during capture of one of the images, and out of the light travel path during capture of the other of the images, comparing the first and second images for clarity and thus selecting one of the first and second images as having greater clarity than the other, and further processing the selected image.

22. A method as in claim 18 wherein the computer contains characteristic enhancement software which enhances image characteristics, the method comprising enhancing characteristics in the images according to pre-determined threshold pixel signal intensity values.

23. A method as in claim 18 wherein the computer contains edge enhancement software which enhances image edges, the method comprising enhancing edges in the images according to pre-determined threshold pixel signal intensity values.

24. A method as in claim 20 wherein the computer contains characteristic enhancement software which enhances image characteristics, the method comprising enhancing characteristics in the images according to pre-determined threshold pixel signal intensity value, plus location proximity to a known qualifying signal in the same image.

25. A method as in claim 20 wherein the computer contains edge enhancement software which enhances image edges, the method comprising enhancing edges in the images according to pre-determined threshold pixel signal intensity value, plus location proximity to a known qualifying signal in the same image.

26. A method as in claim 18, the issuing of commands to the vehicle wash apparatus including at least one of “admit vehicle to the bay”, “stop vehicle”, “start wash cycle”, “stop wash cycle”, “move apparatus”, and “terminate cycle”.

27. A camera-based imaging system, comprising:
(a) an image receiving camera which receives image information related to an operational field of view of said camera, said image receiving camera comprising an array of sensors, and having a light travel path, said camera being adapted to transmit images sensed at both visible light wavelengths and at near infrared light wavelengths; and
(b) interface apparatus which translates the image information into electronic visual information, which can be presented visually on a video monitor,
said camera having a light travel path, and being designed to transmit images received at both visible light wavelengths and at near infrared light wavelengths, the camera further comprising a filter which filters out visible wavelength light.

28. A camera-based imaging system as in claim 27 wherein said filter comprises a long pass filter.

29. A camera-based imaging system as in claim 28, further comprising an illuminating light of sufficient intensity, and at a wavelength which is being passed through the camera to the array of sensors, so as to enhance at least one of clarity of the image or intensity of the image.

30. A camera-based system as in claim 28, further comprising image enhancement software associated with said computer, thereby to enhance the images so captured by said imaging system.

31. A camera-based system as in claim 28 wherein the filter is movable, upon command of the computer, at least one of into the light travel path and out of the light travel path.

32. A camera-based system as in claim 28 wherein the imaging system further comprises a video monitor which receives and/or displays the visual information.
